(19) United States
(12) Patent Application Publication
(10) Pub. No.: US 2024/0232294 A1
(43) Pub. Date: Jul. 11, 2024

(54) COMBINING STRUCTURED AND SEMI-STRUCTURED DATA FOR EXPLAINABLE AI

(71) Applicant: SAP SE, Walldorf (DE)

(72) Inventors: Sai Sree Inavalli, Vijayawada (IN); Sreya Dey, Bangalore (IN); Vishal Mour, Bangalore (IN)

(21) Appl. No.: 18/095,297

(22) Filed: Jan. 10, 2023

(51) Int. Cl. G06F 18/214; G06F 40/40

(52) U.S. Cl. CPC G06F 18/214; G06F 40/40

(57) ABSTRACT

Example methods and systems are directed to combining structured and semi-structured data for explainable artificial intelligence (AI). A machine-learning model is trained using a training set that combines both structured (tabular) data and semi-structured (text) data. Explainable AI refers to systems and methods for generating explanations for the output of machine-learning models. By analyzing the way in which the output of the machine-learning model depends on the inputs to the machine-learning model, a relationship between the inputs and the outputs can be determined. The text data may be converted to tabular data using vector embeddings. The original tabular data may be combined with the converted text data to generate unified structured data. The unified structured data may be provided to a tabular explanation model, which can generate an explanation that is based both on the text data and the tabular data.

### TECHNICAL FIELD

The subject matter disclosed herein generally relates to explainable artificial intelligence (AI). Specifically, the present disclosure addresses systems and methods to combine structured and semi-structured data for explainable AI.

### BACKGROUND

Machine learning models are applications that provide computer systems the ability to perform tasks, without explicitly being programmed, by making inferences based on patterns found in the analysis of data. Machine learning explores the study and construction of algorithms, also referred to herein as models, that may learn from existing data and make predictions about new data. The dimensions of the input data are referred to as features. Trained machine-learning models (also referred to as AI) are black boxes that produce output based on input but do not reveal the methods used to determine the output.

### BRIEF DESCRIPTION OF THE DRAWINGS

Some embodiments are illustrated by way of example and not limitation in the figures of the accompanying drawings.

FIG. 1 is a network diagram illustrating a network environment suitable for combining structured and semi-structured data for explainable AI, according to some example embodiments.

FIG. 2 is a block diagram of an explainable AI server, suitable for combining structured and semi-structured data for explainable AI, according to some example embodiments.

FIG. 3 is a block diagram of a neural network, according to some example embodiments, suitable for use in a machine-learning model.

FIG. 4 is a block diagram of a neural network, according to some example embodiments, suitable for use in generating word vectors.

FIG. 5 is a block diagram of a database schema, according to some example embodiments, suitable for use in combining structured and semi-structured data for explainable AI.

FIG. 6 is a flow diagram illustrating data and operations in generating separate text and tabular model explainers for a model trained on both text and tabular data, according to some example embodiments.

FIG. 7 is a flow diagram illustrating data and operations in generating separate text and tabular model explanations for the separate text and tabular model explainers of FIG. 6, according to some example embodiments.

FIG. 8 is a flow diagram illustrating data and operations in generating a unified text and tabular model explainer for a model trained on both text and tabular data, according to some example embodiments.

FIG. 9 is a flowchart illustrating operations of a method suitable for combining structured and semi-structured data for explainable AI, according to some example embodiments.

FIG. 10 is a block diagram showing one example of a software architecture for a computing device.

FIG. 11 is a block diagram of a machine in the example form of a computer system within which instructions may be executed for causing the machine to perform any one or more of the methodologies discussed herein.

### DETAILED DESCRIPTION

Example methods and systems are directed to combining structured and semi-structured data for explainable AI. As used herein, structured data refers to data in a standardized format that conforms to a data model, has a well-defined structure, and follows a persistent order. For example, responses to a survey that asks for numerical ratings on a 5-point scale for four different questions are structured data: each response comprises four numbers in the range of 1-5 (perhaps with an additional value to indicate that a response was skipped). Semi-structured data refers to data that has some structure, but does not have a fixed schema. For example, responses to a survey that asks for textual answers to four different questions are semi-structured data: each response comprises four text answers and an indication of which question the answer applies to, but the length of the answers may vary and interpretation of the answers is subjective.

A machine-learning model is trained using a training set that combines both structured (also referred to as tabular) data and semi-structured (also referred to as text) data. Each element of the training set is an input for the machine-learning model (e.g., an input data object). By processing the training set, the internal variables of the machine learning model are adjusted so that the error rate of the machine learning model is minimized. If the training set is large and representative of data not included in the training set, the trained model will have comparable results on other data.

Explainable AI refers to systems and methods for generating explanations for the output of machine-learning models. For example, an explanation for the output of a machine-learning model for a specific input vector may be generated by repeatedly modifying a single value of the input vector and generating another output of the machine-learning model. By analyzing the way in which the output of the machine-learning model depends on the inputs to the machine-learning model, a relationship between the inputs and the outputs can be determined.

A tabular explanation model operates on tabular data. A text explanation model operates on text. To generate an explanation of a machine-learning model trained on a combination of tabular and text data using a tabular explanation model and a text explanation model, both explanation models are used and the results combined. The combination may be inaccurate because the separate models are unable to detect any interrelationship between the tabular data and the text data.

The text data may be converted to tabular data using vector embeddings. A mapping of words to vectors is performed to convert data from human-readable text to a form usable by a machine learning model. However, there is no fixed mapping that is suitable for all applications. Thus, learning the mapping to be used is often part of training a machine learning model that operates on text input.

The original tabular data may be combined with the converted text data to generate unified structured data. The unified structured data may be provided to a tabular explanation model, which can generate an explanation that is based both on the text data and the tabular data. Accordingly, the explanation may include interrelationships between the tabular data and the text data, and thus be more accurate than one created using two explanation models.

When these effects are considered in aggregate, one or more of the methodologies described herein may obviate a need for certain efforts or resources that otherwise would be involved in explainable AI. Computing resources used by one or more machines, databases, or networks may similarly be reduced. Examples of such computing resources include processor cycles, network traffic, memory usage, data storage capacity, power consumption, and cooling capacity.

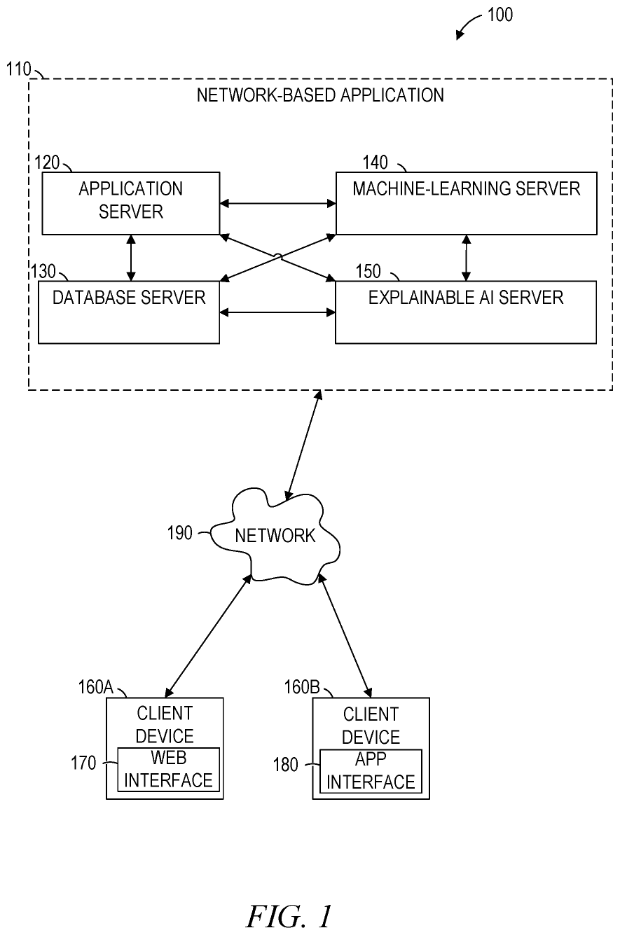

FIG. 1 is a network diagram illustrating a network environment 100 suitable for combining structured and semi-structured data for explainable AI, according to some example embodiments. The network environment 100 includes a network-based application 110, client devices 160A and 160B, and a network 190. The network-based application 110 is provided by application server 120 in communication with a database server 130, a machine-learning server 140, and an explainable AI server 150. The application server 120 accesses application data (e.g., application data stored by the database server 130) to provide one or more applications to the client devices 160A and 160B via a web interface 170 or an application interface 180. For example, the application server 120 may provide a support application that receives help requests from the client devices 160, routes each help request to a service account based on the content of the help request using a machine-learning model provided by the machine-learning server 140, receives responses from the service accounts, and sends the response to each help request to the requesting client device 160.

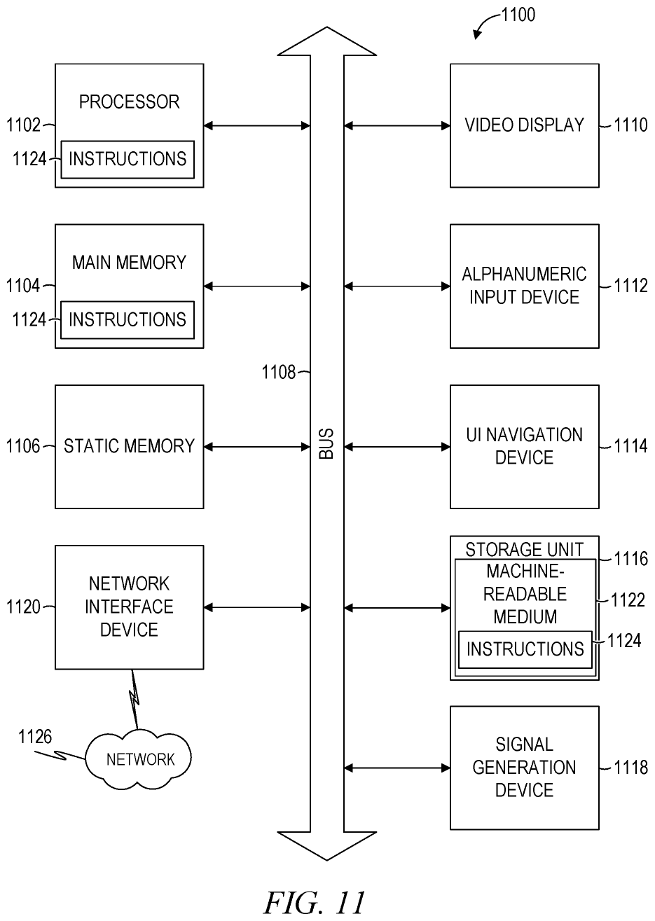

The application server 120, the database server 130, the machine-learning server 140, the explainable AI server, and the client devices 160A and 160B may each be implemented in a computer system, in whole or in part, as described below with respect to FIG. 11. The client devices 160A and 160B may be referred to collectively as client devices 160 or generically as a client device 160.

The machine-learning server 140 accesses training data from the database server 130. Using the training data, the machine-learning server 140 trains a machine learning model that is used by the application server 120. Continuing with the example of a support application, the application server 120 may use the trained machine learning model to suggest answers for support requests, route the support requests to an appropriate support account, or both. Thus, the machine-learning model may provide answers or routing instead of having a human read the help request and make a judgment as to which service account or answer is correct. In this way, customer support is faster and less expensive.

The explainable AI server 150 accesses the training data from the database server 130 and the trained machine-learning model from the machine-learning server 140. Using the training data and output from the machine-learning model, the explainable AI server 150 trains a model explainer that generates global and local explanations for results generated by the trained machine-learning model.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, the machine-learning server 140, the explainable AI server 150, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

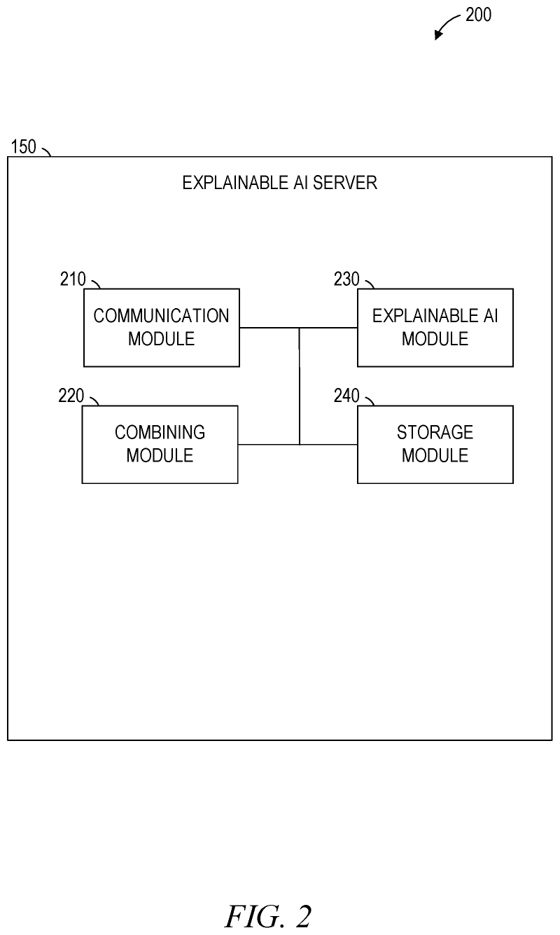

FIG. 2 is a block diagram 200 of the explainable AI server 150, suitable for combining structured and semi-structured data for explainable AI, according to some example embodiments. The explainable AI server 150 is shown as including a communication module 210, a combining module 220, an explainable AI module 230, and a storage module 240, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to explainable AI server 150 and transmits data from the explainable AI server 150. For example, the communication module 210 may receive, from the application server 120 or the database server 130, training data. Text components of the training data may be converted to numerical vectors and combined, by the combining module 220, with numerical components of the training data to generate unified tabular data. The unified tabular data is used, by the explainable AI module 230, to generate an explanation method for a trained machine-learning model. The text of the training data may be processed using NLP to perform the conversion. Communications sent and received by the communication module 210 may be intermediated by the network 190.

The storage module 240 may store data locally on the explainable AI server 150 (e.g., in a hard drive) or store data remotely. Examples of remote storage include network storage devices and the database server 130.

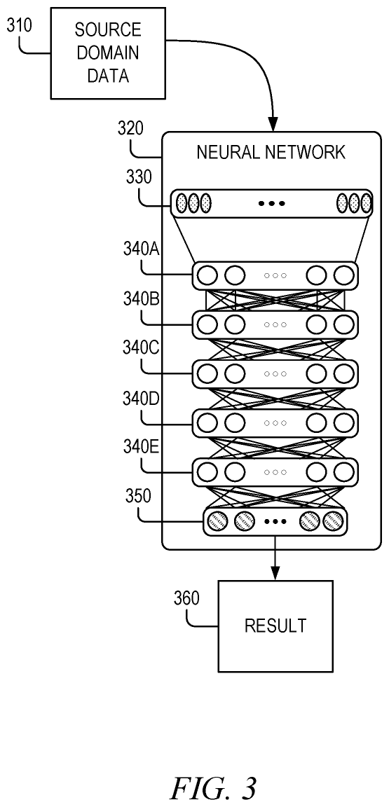

FIG. 3 illustrates the structure of a neural network 320, according to some example embodiments. The neural network 320 takes source domain data 310 as input, processes the source domain data 310 using the input layer 330; the intermediate, hidden layers 340A, 340B, 340C, 340D, and 340E; and the output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 340 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between 1 and the size of the training dataset while the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the networked trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LS™ layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like.

With the help of natural language processing (NLP) and advanced data pre-processing, a machine learning model (e.g., the neural network 320) can be trained on all historical (existing) business entities (for instance, incidents, email interactions, etc.) from the system to assign them with a certain set of keywords or a dominant topic label based on textual fields such as description, subject, and so forth.

A topic label can be a human readable phrase or word specific to the industry that it belongs to. It can be determined based on a set of keywords. For instance, if an object contains a long text of multiple words, this model will detect the most “relevant” and “important” keywords and assign them to different ensembles based on multiple factors. Some factors include feature importance and linguistic proximity. Feature importance is an NLP technique used to determine the most important and relevant textual fields provided from an input. Linguistic proximity refers to a distance between vector representations of keywords in two (or more) textual inputs. Additional factors include word commonalities, n-gram commonalities, and the like.

Related data objects may be assigned a human-legible “topic.” Based on the existing topics and the contents of a new data object, the new data object is automatically assigned to one of the existing topics.

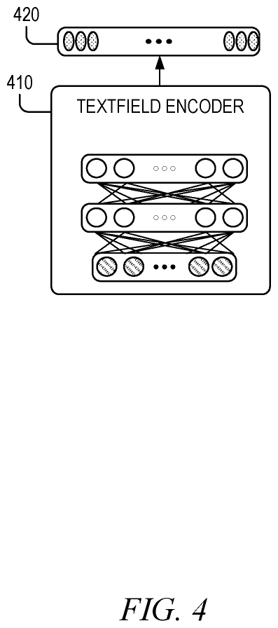

FIG. 4 is a block diagram of a textfield encoder 410, according to some example embodiments, suitable for use in generating word vectors. The textfield encoder 410 generates resulting vector 420. The textfield encoder 410 is trained so that the distance (or loss) function for two related text fields is reduced or minimized.

The specific architecture of the textfield encoder 410 may be chosen dependent on the type of input data for an embedding layer that is followed by some encoder architecture that creates a vector from the sequence. Embeddings and encoder parameters are shared between the text fields. In the simplest case, the encoder stage is just an elementwise average of the token embeddings.

In some example embodiments, the word vectors are normalized so that each word vector has a magnitude of one. A vector for text comprising multiple words may be obtained by averaging the vectors of the words in the text. To determine the difference between two vectors, the Euclidean distance formula may be used, taking the square root of the sum of the squares of the differences of corresponding elements of the two vectors.

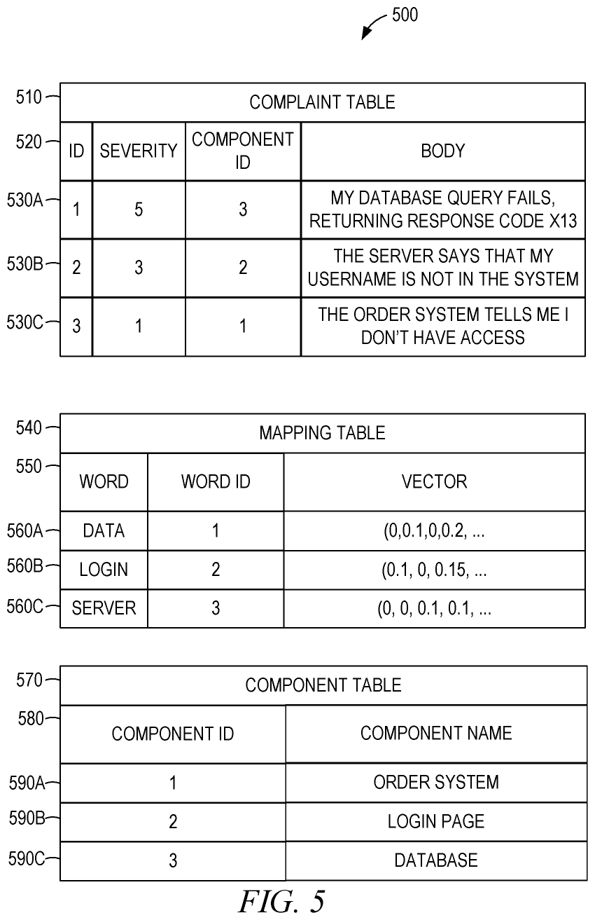

FIG. 5 is a block diagram of a database schema 500, according to some example embodiments, suitable for use in combining structured and semi-structured data for explainable AI. The database schema 500 includes a complaint table 510, a mapping table 540, and a component table 570. The complaint table 510 includes rows 530A, 530B, and 530C of a format 520. The mapping table 540 includes rows 560A, 560B, and 560C of a format 550. The component table 570 includes rows 590A, 590B, and 590C of a format 580.

The format 520 of the complaint table 510 includes a complaint identifier field, a severity field, a component identifier field, and a body field. Each of the rows 530A-530C stores data for a single complaint. The complaint identifier is a unique identifier for the complaint. For example, when a complaint is received, the application server 120 may assign the next unused identifier to the received complaint. The severity is a numerical value (e.g., on a five-point scale) that indicates the severity of the problem being complained about. The component identifier is a numerical value that indicates the component of the application being complained about. The body of the complaint is a text field. Each row in the complaint table comprises both numerical data and text data.

The format 550 of the mapping table 540 includes a word, a scalar word identifier for the word, and a vector that is mapped to the word. In some example embodiments, the word vector is in a high-dimensional space (e.g., includes one hundred or more dimensions). Accordingly, only a portion of each vector is shown in FIG. 5. The contents of the mapping table 540 may be created by the machine-learning server 140 of FIG. 1 using the data in the complaint table 510 as input to the textfield encoder 410 of FIG. 4.

Each of the rows 590A-590C of the component table 570 includes a component identifier and a component name, as indicated by the format 580. The component identifier corresponds to the component identifier of one of the rows 530A-530C. The component name indicates the name of the component. By using a mapping of component names to numeric values, the complaint table 510 is enabled to store a numeric value to represent the component for a complaint, increasing the amount of tabular data and decreasing the amount of text data. For many types of machine-learning models, processing numeric inputs gives better results than processing text inputs, so this substitution results in an improvement of performance.

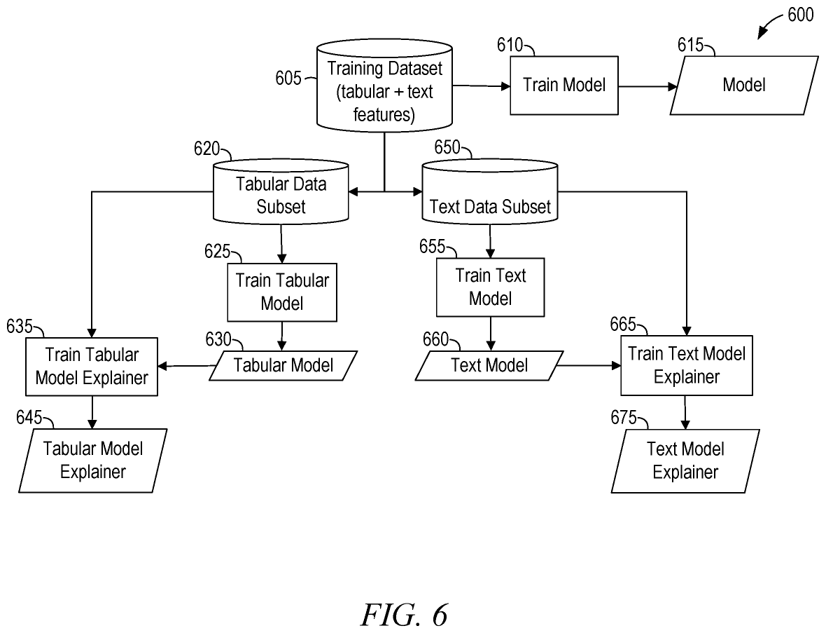

FIG. 6 is a flow diagram 600 illustrating data and operations in generating separate text and tabular model explainers for a model trained on both text and tabular data, according to some example embodiments.

A training dataset 605, comprising both tabular and text features, is used in operation 610 to train a model 615. The trained model 615 may be used to generate predictions based on data entries not present in the training dataset 605. For example, the training dataset 605 may comprise data from the complaint table 510 of FIG. 5, labeled with identification of a knowledge base entry that contains information responsive to the complaint. The trained model 615 may then be used to suggest knowledge base entries for future complaints.

The tabular and text data of the training dataset 605 are extracted to form a tabular data subset 620 and a text data subset 650. The tabular data subset 620, in operation 625, is used to train a tabular model 630. The text data subset 650, in operation 655, is used to train a text model 660. Each of the tabular model 630 and the text model 660 may be less accurate than the model 615, since the tabular model 630 and the text model 660 have access to only a subset of the data used by the model 615.

The tabular data subset 620 is used, in operation 635, in conjunction with the tabular model 630 to train a tabular model explainer 645. The tabular model explainer 645 is an explainable algorithm that approximates the results of the tabular model 630. For example, the tabular model explainer 645 may generate results based on linear and non-linear functions of the input variables without using hidden variables or feedback loops. Thereafter, the relative importance of the input variables may be explained by evaluating the tabular model explainer 645 using the same inputs as the tabular model 630.

Similar operations are performed with regard to the text data subset 650. The text data subset 650 is used, in operation 655, in conjunction with the text model 660 to train a text model explainer 675. The text model explainer 675 is an explainable algorithm that approximates the results of the tabular model 630. Thereafter, the relative importance of the input variables may be explained by evaluating the text model explainer 675 using the same inputs as the tabular model 630.

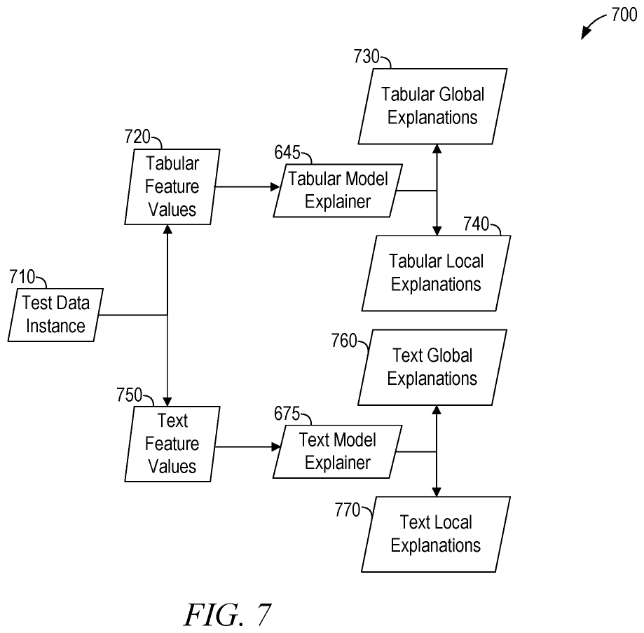

FIG. 7 is a flow diagram 700 illustrating data and operations in generating separate text and tabular model explanations for the separate text and tabular model explainers of FIG. 6, according to some example embodiments.

An explanation of the method by which the model 615 generates a result for a test data instance 710 is desired. The test data instance 710 is of the same format as the data in the training dataset 605, and thus includes both text features and tabular features. The test data instance 710 is divided into its tabular feature values 720 and its text feature values 750.

The tabular feature values 720 are provided as input to the tabular model explainer 645, which generates tabular global explanations 730 and tabular local explanations 740. The tabular global explanations 730 provide components of the explanation that apply to all tabular inputs to the tabular model 630; the tabular local explanations 740 provides components of the explanation that apply to tabular inputs to the tabular model 630 in the vicinity of the tabular feature values 720.

Similarly, the text feature values 750 are provided as input to the text model explainer 675, which generates text global explanations 760 and text local explanations 770. The text global explanations 760 provide components of the explanation that apply to all text inputs to the text model 660; the text local explanations 770 provides components of the explanation that apply to text inputs to the text model 660 in the vicinity of the text feature values 750.

In combination, the tabular global explanations 730, the tabular local explanations 740, the text global explanations 760, and the test local explanations 770 provide some explanation value as to the results from the model 615. However, the inputs to the tabular model explainer 645 and the text model explainer 675, comprising either tabular data or text data, are different from the input to the model 615, comprising both tabular data and text data. Likewise, the training of the tabular model 630 and the text model 660 was performed using different data (either tabular or text, but not both) than that used to train the model 615. Accordingly, the explanation results generated in FIG. 7 may or may not accurately reflect the workings of the model 615.

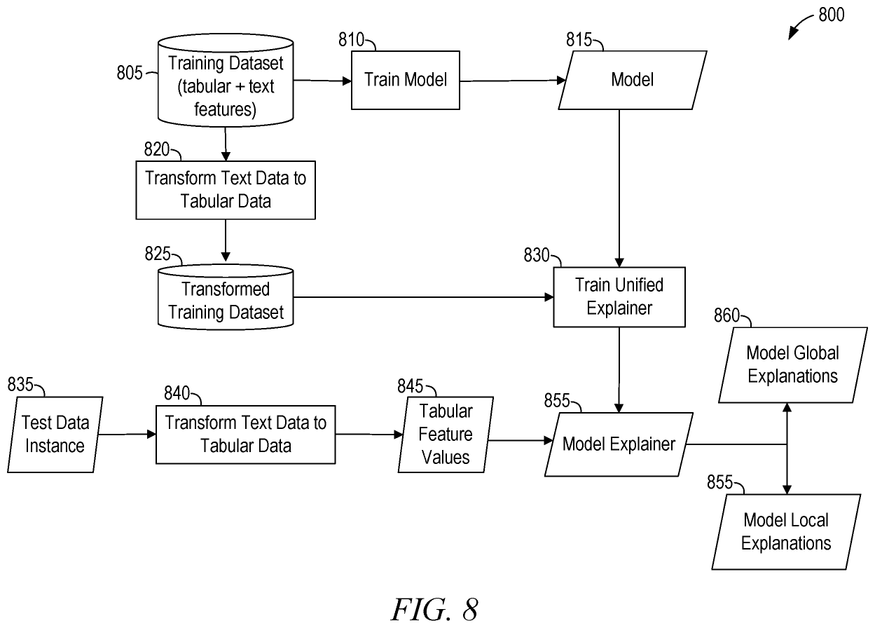

FIG. 8 is a flow diagram 800 illustrating data and operations in generating a unified text and tabular model explainer for a model trained on both text and tabular data, according to some example embodiments.

A training dataset 805, comprising both tabular and text features, is used in operation 810 to train a model 815. The trained model 815 may be used to generate predictions based on data entries not present in the training dataset 805. For example, the training dataset 805 may comprise data from the complaint table 510 of FIG. 5, labeled with identification of a knowledge base entry that contains information responsive to the complaint. The trained model 815 may then be used to suggest knowledge base entries for future complaints.

In operation 820, the text data of the training dataset 805 is transformed into tabular data. For example, the words of the text data may be used with the mapping table 540 to generate a vector that represents the text.

The transformed text data generated in operation 820 is replaces the text features of the training dataset 805 in a transformed training dataset 825. Thus, the transformed training dataset 825 includes all of the features of the training dataset 805, but the text is now represented in a numeric form. Thus, the transformed training dataset 825 comprises only tabular features while the training dataset 805 comprises both tabular and text features.

The transformed training dataset 825 is used, in operation 830, in conjunction with the model 815 to train a model explainer 855. The combining module 220 generates a training set that labels the transformed training dataset 825 with outputs from the model 815 generated from corresponding entries in the training dataset 805. Thus, while the model 815 is trained to generate outputs that are as similar as possible to the labels provided in the training dataset 805, the model explainer 855 is trained to generate outputs that are as similar as possible to the outputs generated by the model 815.

The model explainer 855 may be generated using techniques for tabular model explainers, since the transformed training dataset 825 consists of tabular data without text data. The model explainer 855 is an explainable algorithm that approximates the results of the model 815. For example, the unified model explainer 855 may generate results based on linear and non-linear functions of the input variables without using hidden variables or feedback loops. Thereafter, the relative importance of the input variables may be explained by evaluating the model explainer 855 using the same inputs as the model 815.

An explanation of the method by which the model 815 generates a result for a test data instance 835 is desired. The test data instance 835 is of the same format as the data in the training dataset 805, and thus includes both text features and tabular features. The text features of the test data instance 835 are converted to tabular data in operation 840, resulting in tabular feature values 845, representing all of the features of the test data instance 835 in tabular form. For example, the text features of the data instance may be converted to a numerical vector by providing the text features to an NLP.

The tabular feature values 845 are provided as input to the model explainer 855, which generates model global explanations 860 and model local explanations 855. The model global explanations 860 provide components of the explanation that apply to all inputs to the model 815; the local explanations 855 provides components of the explanation that apply to inputs to the model 815 in the vicinity of the test data instance 835.

In combination, the model global explanations 860 and the model local explanations 855 provide explainable AI for the model 815. Unlike the results generated using the flow diagram 700 of FIG. 7, the inputs to the model explainer 855 comprise all features used to train the model 815. Accordingly, by comparison with the results generated in FIG. 7, the explanation results generated in FIG. 8 more accurately reflect the workings of the model 815.

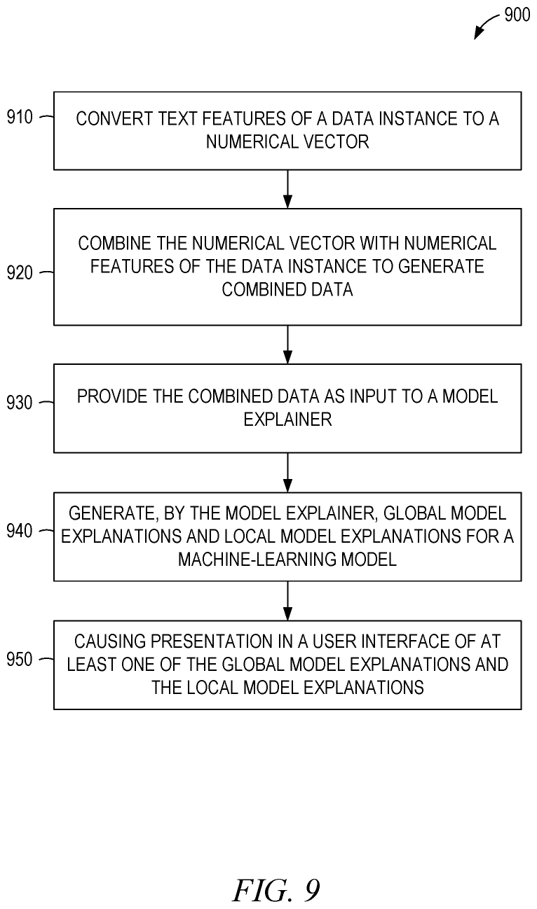

FIG. 9 is a flowchart illustrating operations of a method 900 suitable for combining structured and semi-structured data for explainable AI, according to some example embodiments. The method 900 includes operations 910, 920, 930, 940, and 950. By way of example and not limitation, the method 900 may be performed by the explainable AI server 150, using the modules, neural networks, database schemas, and process flows of FIGS. 2-8.

In operation 910, the combining module 220 converts text features of a data instance to a numerical vector. For example, words in the text features may be converted to vector form by using the textfield encoder 410 of FIG. 4 or the mapping table 540 of FIG. 5. The vectors of the words in a text feature may be summed or averaged to generate a single vector for the text feature. The vectors of words in different text features may be kept separate.

The combining module 220, in operation 920, combines the numerical vector with numerical features of the data instance to generate combined data. For example, a combined data entry may be generated by replacing the body field (a text feature) of a row of the complaint table 510 with a vector of the text feature.

In operation 930, the combined data is provided as input to a model explainer (e.g., the explainable AI module 230 of FIG. 2 or the model explainer 855 of FIG. 8). The model explainer generates, in operation 940, global model explanations and local model explanations for a machine-learning model (e.g., the model 815 of FIG. 8).

The explainable AI server 150 causes presentation in a user interface of at least one of the global model explanations and the local model explanations. For example, a user interface may be caused to be presented on a display device of the client device 160A of FIG. 1 by transmitting a web page from the explainable AI server 150 for rendering by a web browser. The user interface may include both the global model explanations and the local model explanations.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors configured by the instructions to perform operations comprising: converting text features of a data instance to a numerical vector; combining the numerical vector with numerical features of the data instance to generate combined data; providing the combined data as input to a model explainer; receiving, from the model explainer, global model explanations and local model explanations for a machine learning model; and causing presentation in a user interface of at least one of the global model explanations and the local model explanations.

In Example 2, the subject matter of Example 1 includes, wherein the operations further comprise: training the machine learning model using a training dataset that comprises both tabular and text features.

In Example 3, the subject matter of Examples 1-2, wherein the operations further comprise: transforming data of a first training dataset that comprises both tabular features and text features into a transformed dataset that comprises only tabular features; and generating a second training set that labels the transformed dataset using outputs from the machine learning model generated from corresponding entries in the first training dataset.

In Example 4, the subject matter of Example 3, wherein the operations further comprise: training the model explainer using the second training set.

In Example 5, the subject matter of Examples 1-4, wherein the causing of presentation in the user interface of at least one of the global model explanations and the local model explanations comprises causing presentation in the user interface of both the global model explanations and the local model explanations.

In Example 6, the subject matter of Examples 1-5, wherein the converting of the text features of the data instance to a numerical vector comprises providing the text features to a NLP.

In Example 7, the subject matter of Examples 1-6, wherein the converting of the text features of the data instance to a numerical vector comprises: converting individual words of the text features to word vectors; and combining the word vectors for each text feature to generate the numerical vector for the text feature.

Example 8 is a non-transitory computer-readable medium that stores instructions that, when executed by one or more processors, cause the one or more processors to perform operations comprising: converting text features of a data instance to a numerical vector; combining the numerical vector with numerical features of the data instance to generate combined data; providing the combined data as input to a model explainer; receiving, from the model explainer, global model explanations and local model explanations for a machine learning model; and causing presentation in a user interface of at least one of the global model explanations and the local model explanations.

In Example 9, the subject matter of Example 8, wherein the operations further comprise: training the machine learning model using a training dataset that comprises both tabular and text features.

In Example 10, the subject matter of Examples 8-9, wherein the operations further comprise: transforming data of a first training dataset that comprises both tabular features and text features into a transformed dataset that comprises only tabular features; and generating a second training set that labels the transformed dataset using outputs from the machine learning model generated from corresponding entries in the first training dataset.

In Example 11, the subject matter of Example 10, wherein the operations further comprise: training the model explainer using the second training set.

In Example 12, the subject matter of Examples 8-11, wherein the causing of presentation in the user interface of at least one of the global model explanations and the local model explanations comprises causing presentation in the user interface of both the global model explanations and the local model explanations.

In Example 13, the subject matter of Examples 8-12, wherein the converting of the text features of the data instance to a numerical vector comprises providing the text features to a NLP.

In Example 14, the subject matter of Examples 8-13, wherein the converting of the text features of the data instance to a numerical vector comprises: converting individual words of the text features to word vectors; and combining the word vectors for each text feature to generate the numerical vector for the text feature.

Example 15 is a method comprising: converting, by one or more processors, text features of a data instance to a numerical vector; combining, by the one or more processors, the numerical vector with numerical features of the data instance to generate combined data; providing, by the one or more processors, the combined data as input to a model explainer; receiving, from the model explainer, global model explanations and local model explanations for a machine learning model; and causing presentation in a user interface of at least one of the global model explanations and the local model explanations.

In Example 16, the subject matter of Example 15 includes training the machine learning model using a training dataset that comprises both tabular and text features.

In Example 17, the subject matter of Examples 15-16 includes transforming data of a first training dataset that comprises both tabular features and text features into a transformed dataset that comprises only tabular features; generating a second training set that labels the transformed dataset using outputs from the machine learning model generated from corresponding entries in the first training dataset.

In Example 18, the subject matter of Example 17 includes training the model explainer using the second training set.

In Example 19, the subject matter of Examples 15-18, wherein the causing of presentation in the user interface of at least one of the global model explanations and the local model explanations comprises causing presentation in the user interface of both the global model explanations and the local model explanations.

In Example 20, the subject matter of Examples 15-19, wherein the converting of the text features of the data instance to a numerical vector comprises providing the text features to a NLP.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

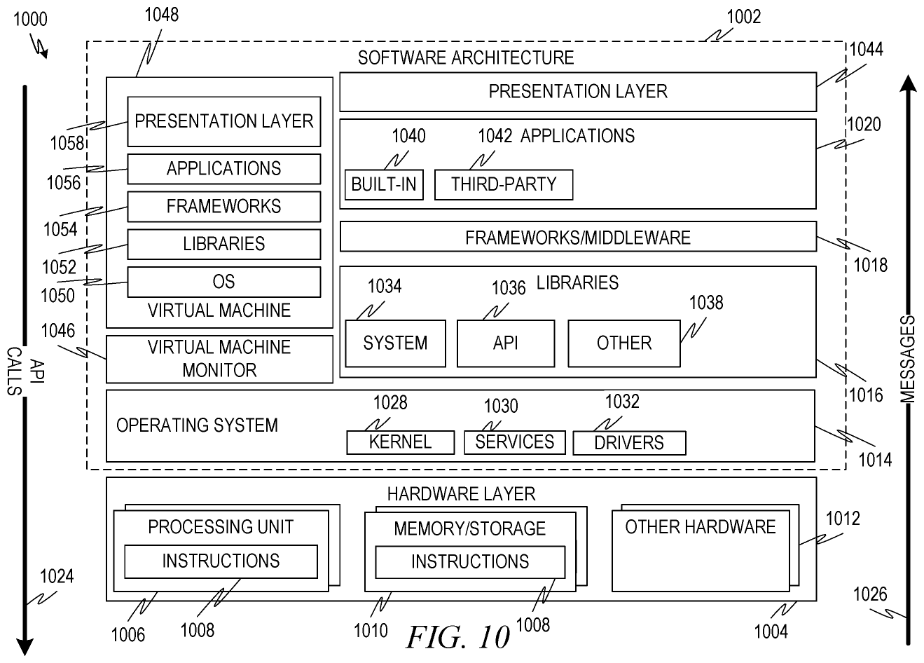

FIG. 10 is a block diagram 1000 showing one example of a software architecture 1002 for a computing device. The architecture 1002 may be used in conjunction with various hardware architectures, for example, as described herein. FIG. 10 is merely a non-limiting example of a software architecture and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 10.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 which represents any other hardware of the hardware layer 1004, such as the other hardware illustrated as part of the software architecture 1002.

In the example architecture of FIG. 10, the software architecture 1002 may be conceptualized as a stack of layers where each layer provides particular functionality. For example, the software architecture 1002 may include layers such as an operating system 1014, libraries 1016, frameworks/middleware layer 1018, applications 1020, and presentation layer 1044. Operationally, the applications 1020 and/or other components within the layers may invoke application programming interface (API) calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware 1018 may provide a higher-level common infrastructure that may be utilized by the applications 1020 and/or other software components/modules. For example, the frameworks/middleware 1018 may provide various graphic user interface (GUI) functions, high-level resource management, high-level location services, and so forth. The frameworks/middleware 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a contacts application, a browser application, a book reader application, a location application, a media application, a messaging application, and/or a game application. Third-party applications 1042 may include any of the built-in applications as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built in operating system functions (e.g., kernel 1028, services 1030 and/or drivers 1032), libraries (e.g., system libraries 1034, API libraries 1036, and other libraries 1038), and frameworks/middleware 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine as well as the interface with the host operating system (i.e., operating system 1014). A software architecture executes within the virtual machine 1048 such as an operating system 1050, libraries 1052, frameworks/middleware 1054, applications 1056 and/or presentation layer 1058. These layers of software architecture executing within the virtual machine 1048 can be the same as corresponding layers previously described or may be different.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### ELECTRONIC APPARATUS AND SYSTEM

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### EXAMPLE MACHINE ARCHITECTURE AND MACHINE-READABLE MEDIUM

FIG. 11 is a block diagram of a machine in the example form of a computer system 1100 within which instructions 1124 may be executed for causing the machine to perform any one or more of the methodologies discussed herein, such as those shown in FIG. 6-9. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation (or cursor control) device 1114 (e.g., a mouse), a storage unit 1116, a signal generation device 1118 (e.g., a speaker), and a network interface device 1120.

### MACHINE-READABLE MEDIUM

The storage unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting machine-readable media 1122.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### TRANSMISSION MEDIUM

The instructions 1124 may further be transmitted or received over a communications network 1126 using a transmission medium. The instructions 1124 may be transmitted using the network interface device 1120 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors configured by the instructions to perform operations comprising:
converting text features of a data instance to a numerical vector;
combining the numerical vector with numerical features of the data instance to generate combined data;
providing the combined data as input to a model explainer;
receiving, from the model explainer, global model explanations and local model explanations for a machine learning model; and
causing presentation in a user interface of at least one of the global model explanations and the local model explanations.

2. The system of claim 1, wherein the operations further comprise:
training the machine learning model using a training dataset that comprises both tabular and text features.

3. The system of claim 1, wherein the operations further comprise:
transforming data of a first training dataset that comprises both tabular features and text features into a transformed dataset that comprises only tabular features; and
generating a second training set that labels the transformed dataset using outputs from the machine learning model generated from corresponding entries in the first training dataset.

4. The system of claim 3, wherein the operations further comprise:
training the model explainer using the second training set.

5. The system of claim 1, wherein the causing of presentation in the user interface of at least one of the global model explanations and the local model explanations comprises causing presentation in the user interface of both the global model explanations and the local model explanations.

6. The system of claim 1, wherein the converting of the text features of the data instance to a numerical vector comprises providing the text features to a natural language processor (NLP).

7. The system of claim 1, wherein the converting of the text features of the data instance to a numerical vector comprises:
converting individual words of the text features to word vectors; and
combining the word vectors for each text feature to generate the numerical vector for the text feature.

8. A non-transitory computer-readable medium that stores instructions that, when executed by one or more processors, cause the one or more processors to perform operations comprising:
converting text features of a data instance to a numerical vector;
combining the numerical vector with numerical features of the data instance to generate combined data;
providing the combined data as input to a model explainer;
receiving, from the model explainer, global model explanations and local model explanations for a machine learning model; and
causing presentation in a user interface of at least one of the global model explanations and the local model explanations.

9. The non-transitory computer-readable medium of claim 8, wherein the operations further comprise:
training the machine learning model using a training dataset that comprises both tabular and text features.

10. The non-transitory computer-readable medium of claim 8, wherein the operations further comprise:
transforming data of a first training dataset that comprises both tabular features and text features into a transformed dataset that comprises only tabular features; and
generating a second training set that labels the transformed dataset using outputs from the machine learning model generated from corresponding entries in the first training dataset.

11. The non-transitory computer-readable medium of claim 10, wherein the operations further comprise:
training the model explainer using the second training set.

12. The non-transitory computer-readable medium of claim 8, wherein the causing of presentation in the user interface of at least one of the global model explanations and the local model explanations comprises causing presentation in the user interface of both the global model explanations and the local model explanations.

13. The non-transitory computer-readable medium of claim 8, wherein the converting of the text features of the data instance to a numerical vector comprises providing the text features to a natural language processor (NLP).

14. The non-transitory computer-readable medium of claim 8, wherein the converting of the text features of the data instance to a numerical vector comprises:
converting individual words of the text features to word vectors; and
combining the word vectors for each text feature to generate the numerical vector for the text feature.

15. A method comprising:
converting, by one or more processors, text features of a data instance to a numerical vector;
combining, by the one or more processors, the numerical vector with numerical features of the data instance to generate combined data;
providing, by the one or more processors, the combined data as input to a model explainer;
receiving, from the model explainer, global model explanations and local model explanations for a machine learning model; and
causing presentation in a user interface of at least one of the global model explanations and the local model explanations.

16. The method of claim 15, further comprising:
training the machine learning model using a training dataset that comprises both tabular and text features.

17. The method of claim 15, further comprising:
transforming data of a first training dataset that comprises both tabular features and text features into a transformed dataset that comprises only tabular features;
generating a second training set that labels the transformed dataset using outputs from the machine learning model generated from corresponding entries in the first training dataset.

18. The method of claim 17, further comprising:
training the model explainer using the second training set.

19. The method of claim 15, wherein the causing of presentation in the user interface of at least one of the global model explanations and the local model explanations comprises causing presentation in the user interface of both the global model explanations and the local model explanations.

20. The method of claim 15, wherein the converting of the text features of the data instance to a numerical vector comprises providing the text features to a natural language processor (NLP).
